(19) United States
(12) Patent Application Publication
(10) Pub. No.: US 2018/0126307 A1
(43) Pub. Date: May 10, 2018

(54) FILTER DEVICE

(71) Applicant: FSP Fluid Systems Partners Holding AG, Baar (CH)

(72) Inventors: Tobias Wendel, Bruchsal (DE); Valentin Pichlmaier, Bretten (DE); Klaus Moessinger, Obersulm (DE)

(21) Appl. No.: 15/708,271

(22) Filed: Sep. 19, 2017

Related U.S. Application Data
(63) Continuation of application No. PCT/EP2015/057778, filed on Apr. 9, 2015.

(51) Int. Cl. B01D 29/90; B01D 35/30; B01D 29/11; B01D 29/96

(52) U.S. Cl. CPC B01D 29/90; B01D 35/30; F15B 21/041; B01D 29/96; B01D 2201/30; B01D 29/114

(57) ABSTRACT

A filter device for filtering hydraulic liquid is provided, which has a housing having a housing upper part and a housing lower part. The housing upper part has a housing inlet and a housing outlet. A filter element is arranged in the housing lower part. The filter element has a dirty side in communication with the housing inlet and a clean side in communication with the housing outlet. The housing upper part comprises a convexly curved interior wall. An insertable flow-guiding element is arranged in the housing upper part which divides the housing upper part into a dirty region and a clean region. The dirty region is in communication with the dirty side of the filter element and the housing inlet opens into the dirty region. The clean region is in communication with the clean side of the filter element and the housing outlet leads out of the clean region.

This application is a continuation of international application number PCT/EP2015/057778 filed on Apr. 9, 2015, which is incorporated herein by reference in its entirety and for all purposes.

### BACKGROUND OF THE INVENTION

The invention relates to a filter device for filtering a hydraulic liquid, comprising a housing having a housing upper part and a housing lower part that can be releasably connected to the housing upper part, wherein the housing upper part has a housing inlet for hydraulic liquid that is to be filtered and a housing outlet for hydraulic liquid that has been filtered and wherein a filter element is arranged in the housing lower part whose dirty side is in flow communication with the housing inlet and whose clean side is in flow communication with the housing outlet.

Such filter devices are used in hydraulic systems, for example on self-propelled machinery, in particular construction machinery and agricultural machinery. Such filter devices permit the filtration of hydraulic liquids, such as mineral oils. To this end, a filter element is used to which the hydraulic liquid to be filtered can be supplied from a housing inlet of the filter device and from which the filtered liquid can be supplied to a housing outlet of the filter device. The housing comprises a housing upper part and a housing lower part which can be releasably connected to the housing upper part. For example, provision may be made for the housing lower part to be connected to the housing upper part by screwing. The housing upper part comprises the housing inlet and the housing outlet, each of which can have a hydraulic conduit connected thereto. The filter element is located in the housing lower part; it can be replaced when required by separating the housing lower part from the housing upper part.

The supply of hydraulic liquid to the dirty side of the filter element, like the removal of filtered liquid from the clean side of the filter element to the housing outlet, is frequently realized by the housing upper part being provided with flow channels formed therein. To this end, the housing upper part is in many cases fabricated by chip-forming working operations or in the form of a casting. Because the hydraulic liquid may be under a high pressure, for example a pressure of several 100 bar, in particular 400 to 500 bar, the housing upper part, like the housing lower part, has a considerable material thickness in order to ensure the mechanical stability required.

A filter device of the kind mentioned above is known from DE 1 436 277 A1.

It is an object of the present invention to improve a filter device of the kind mentioned at the outset such that it can be produced more cost-effectively.

### SUMMARY OF THE INVENTION

This object is accomplished, in accordance with the invention, in a filter device of the generic kind in that the housing upper part comprises an interior wall that is curved convexly outward along the entire circumference thereof and in that an insertable flow-guiding element is arranged in the housing upper part which divides the interior space of the housing upper part in a dirty region and a clean region, wherein the dirty region is in flow communication with the dirty side of the filter element and the housing inlet opens into the dirty region and wherein the clean region is in flow communication with the clean side of the filter element and the housing outlet leads out of the clean region.

In the filter device constructed in accordance with the invention, a housing upper part is used whose interior wall is curved convexly outward along the entire circumference thereof. Hence, when viewed in a top view, the interior wall has an oval, in particular elliptical, or also a circular shape. This permits the housing upper part to be fabricated with a relatively small material thickness and yet impart a high compressive rigidity to the housing upper part. The interior wall of the housing upper part contains practically no abrupt changes in shape along its circumference about the longitudinal axis of the housing, at which points mechanical stress peaks could occur when under a pressure load of several 100 bar, in particular under a pressure load of 400 to 500 bar. Hence, the material thickness of the housing upper part can be chosen to be relatively small and the housing upper part can be cost-effectively produced without need for chip-forming working operations.

The housing lower part of the filter device constructed in accordance with the invention is preferably of cylindrical configuration so that the interior wall of the housing lower part is also convexly curved along the entire circumference thereof and, as a consequence, the housing lower part also has a high compressive rigidity with relatively small material thickness.

In order to be able to supply the hydraulic liquid to be filtered to the dirty side of the filter element and remove the filtered liquid from the clean side of the filter element, the filter device constructed in accordance with the invention uses a flow-guiding element which is adapted to be inserted in the housing upper part. The flow-guiding element divides the housing upper part in a dirty region and a clean region. The housing inlet opens into the dirty region, and the dirty side of the filter element is in flow communication with the dirty region so that the hydraulic liquid to be filtered can be supplied to the filter element via the dirty region. The clean region is in flow communication with the clean side of the filter element and the housing outlet leads out of the clean region so that the filtered hydraulic liquid can be supplied to the housing outlet via the clean region. There is therefore no need for the housing upper part to have additional flow channels integrally formed therein.

The flow-guiding element can be cost-effectively fabricated from a plastics material because it will be subjected substantially only to the pressure load that results from the pressure difference that occurs at the filter element. The hydraulic liquid experiences a pressure drop of some bar, for example 3 to 5 bar, during its passage through the filter element. As a result, the pressure of the hydraulic liquid in the dirty region of the housing differs from the pressure of the hydraulic liquid in the clean region only by a few bar and the flow-guiding element inserted in the housing upper part need withstand only this relatively small pressure difference. While, when the filter device is used in high-pressure applications, in particular applications in the range of 400 to 500 bar, the housing upper part, like the housing lower part, is advantageously made of metal, the flow-guiding element can be cost-effectively produced from a plastics material.

In the filter device constructed in accordance with the invention, the interior wall of the housing upper part is of a circular or oval shape, as has already been noted. It is particularly advantageous for the interior wall of the housing upper part to be configured with a circular or elliptical shape in a plane oriented perpendicularly to a longitudinal axis of the housing. The longitudinal axis of the housing is advantageously aligned in line or parallel with the longitudinal axis of the filter element and extends from a top wall of the housing upper part to a bottom wall of the housing lower part.

In an advantageous embodiment of the invention, the interior wall of the housing upper part has an elliptical-shaped interior wall section at a level of the housing inlet and the housing outlet relative to the longitudinal axis of the housing and the interior wall of the housing upper part has a circular-shaped interior wall section in an end region of the housing upper part that faces towards the housing lower part. Providing an elliptical-shaped interior wall section at a level of the housing inlet and the housing outlet is advantageous in that the material thickness of the housing upper part can be chosen to be greater in the area of the housing inlet and the housing outlet than in the circumferential area between the housing inlet and the housing outlet, and providing a circular-shaped interior wall section in the end region facing towards the housing lower part is advantageous in that the interior wall in this end region can carry an internal thread into which the housing lower part can be threaded with a complementarily configured external thread.

It is particularly advantageous for the radius of the circular-shaped interior wall section to be greater than the semi-major axis of the elliptical-shaped interior wall section. Hence, in such a configuration, the interior space of the housing upper part expands in a direction towards the housing lower part. This facilitates the provision of an internal thread in the area of the housing upper part adjoining the housing lower part without thereby adversely affecting the flow communication between the housing inlet and the dirty side of the filter element or the flow communication between the clean side of the filter element and the housing outlet.

In an advantageous configuration of the invention, the exterior wall of the housing upper part comprises exterior wall sections curved convexly outward in a circumferential direction between the housing inlet and the housing outlet. By the convexly outwardly curved shape of the exterior wall in the circumferential area between the housing inlet and the housing outlet, the housing upper part is imparted a particularly high compressive rigidity, wherein the material thickness of the housing upper part can be kept relatively small.

In the area of the housing inlet and/or in the area of the housing outlet, the exterior wall can be of planar configuration in order to simplify the establishment of a connection of each of the housing inlet and the housing outlet with a hydraulic conduit. The planar areas of the housing exterior wall can extend in a longitudinal direction of the housing upper part from the upper side thereof to the lower side thereof.

It is advantageous for the exterior wall of the housing upper part to comprise circular arc-shaped or elliptical arc-shaped exterior wall sections in a circumferential direction between the housing inlet and the housing outlet.

For example, provision may be made for the exterior wall of the housing upper part to be of circular arc-shaped configuration in the circumferential area between the housing inlet and the housing outlet and for the interior wall of the housing upper part to be of elliptical-shaped configuration. Alternatively, provision may be made for the exterior wall in the circumferential area between the housing inlet and the housing outlet to have an elliptical arc-shaped configuration and for the interior wall section of the housing upper part to have a circular-shaped configuration. Furthermore, provision may be made for the exterior wall in the circumferential area between the housing inlet and the housing outlet to be of elliptical arc-shaped configuration and for the interior wall of the housing upper part to be of elliptical-shaped configuration, advantageously wherein the eccentricities of the interior wall and the exterior wall are different. The combination of a circular shape and an ellipse, like the combination of two ellipses having different eccentricities, is advantageous in that the material thickness of the housing upper part can be chosen to be larger in the area between the housing inlet and the housing outlet than in circumferential areas between the housing inlet and the housing outlet, wherein despite different material thicknesses, no abrupt changes in stiffness occur, at which points stress peaks adversely affecting the mechanical stability of the housing upper part can occur when the housing upper part is under a high pressure load.

Making provision for a material thickness that is larger in the area of the housing inlet and the housing outlet than in the area between the housing inlet and the housing outlet is advantageous in that the housing inlet, like the housing outlet, can have an internal thread with a plurality of thread grooves formed therein so that the housing inlet and the housing outlet each can have screwed thereinto a coupling element having an external thread of complementary configuration, wherein the screwed connection also withstands very high pressure load. The material thickness in the circumferential area between the housing inlet and the housing outlet, however, can be chosen to be smaller.

As has already been mentioned, it is advantageous for areas of different material thicknesses of the housing upper part to transition continuously one into the other because it is thereby possible to avoid stress peaks adversely affecting the compressive rigidity of the housing upper part, even when the housing upper part is placed under a high pressure load.

The housing outlet is advantageously located diametrically opposite the housing inlet.

It is particularly advantageous for the housing outlet to be arranged at the same level as the housing inlet, relative to the longitudinal axis of the housing.

In an advantageous embodiment of the invention, the housing upper part is fabricated by cold forming or hot forming. For example, provision may be made for the housing upper part to be configured as an extruded steel part or as a forging.

Thus far, no details have been given about the configuration of the flow-guiding element. In an advantageous embodiment of the invention, the flow-guiding element comprises a separating disk having a sealing element which is adapted to be placed into sealing contact against the interior wall of the housing upper part. By way of the sealing element, the dirty region can be reliably separated from the clean region so that it is ensured that hydraulic liquid to be filtered cannot get directly from the dirty region to the clean region, without having previously passed through the filter element.

The sealing element arranged at the separating disk is preferably configured as a sealing lip integrally formed on the separating disk. The configuration in the form of a sealing lip imparts to the sealing element a high level of elastic deformation capability so that the sealing element can easily conform to the shape of the interior wall of the housing upper part when the flow-guiding element is inserted in the housing upper part.

It is advantageous for the separating disk to be at an incline with respect to the longitudinal axis of the housing, wherein the housing inlet opens into the housing upper part on a first side of the separating disk, preferably the side of the separating disk facing towards the filter element, and wherein the housing outlet leads out of the housing upper part on the second side of the separating disk, opposite the first side thereof, preferably the side of the separating disk that faces away from the filter element.

Hydraulic liquid flowing via the housing inlet into the housing upper part preferably directly enters a dirty region arranged below the separating disk whence the hydraulic liquid can reach the dirty side of the filter element. Filtered hydraulic liquid is supplied from the clean side of the filter element to, preferably, the area above the separating disk whence the filtered liquid can flow out of the housing via the housing outlet.

In an advantageous embodiment of the invention, the filter element forms a cylindrical filter cartridge which is adapted to be connected to the flow-guiding element in a releasable and flow-tight manner, and the flow-guiding element has at least one passageway for filtered hydraulic liquid.

The filter cartridge may be oriented in line or parallel with the longitudinal axis of the housing of the filter device and have its dirty side assume a distance from the interior wall of the housing lower part so that an annular space is created between the dirty side of the filter cartridge and the interior wall of the housing lower part to which the liquid to be filtered can be supplied. The hydraulic liquid can flow through the filter cartridge radially from outside to inside, i.e. the clean side of the filter cartridge is arranged at the inner side thereof. The filtered liquid can pass from the clean side of the filter cartridge via the at least one passageway of the flow-guiding element to an area arranged above the flow-guiding element whence the filtered liquid can flow out of the housing via the housing outlet.

Preferably, the filter cartridge comprises an upper end disk facing towards the flow-guiding element and a lower end disk facing away from the flow-guiding element, and arranged between the upper end disk and the lower end disk is a filter material, wherein a sleeve-shaped connecting part is positioned at the upper end disk, said sleeve-shaped connecting part being releasably connectable to a sleeve-shaped coupling part of the flow-guiding element. The connecting part and the coupling part provide a simple way for the filter cartridge to be releasably connected to the flow-guiding element.

Advantageously, the coupling part is connected in one piece to the separating disk. In a preferred configuration of the invention, the separating disk and the coupling part form a one-piece, shaped plastic part.

Preferably, the connecting part and the coupling part are pluggably connectable together. For example, provision may be made for the connecting part to be pluggable into the coupling part. Alternatively, provision may be made for the coupling part to be pluggable into the connecting part.

Advantageously, a sealing element is arranged at the connecting part and/or at the coupling part, said sealing element ensuring that unfiltered hydraulic liquid cannot get directly into the coupling part, without having previously passed through the filter cartridge.

The sealing element which is arranged at the connecting part or at the coupling part is advantageously integrally formed on the connecting part or on the coupling part respectively.

It is particularly advantageous for the sealing element arranged at the connecting part and/or at the coupling part to be configured as a sealing lip.

As has already been mentioned, the flow-guiding element is subjected to a relatively low pressure load, even when the pressure of the hydraulic liquid overall is several 100 bar. However, in order to keep the material usage of the flow-guiding element as low as possible, it is advantageous for the flow-guiding element to comprise at least one supporting rib that is adapted to be placed in contact against the interior wall of the housing upper part. Via the at least one supporting rib, the flow-guiding element can be supported on the interior wall of the housing upper part.

As has already been mentioned, it is advantageous for the flow-guiding element to comprise a separating disk that is oriented at an incline with respect to the longitudinal axis of the housing. In such a configuration, it is advantageous for at least one supporting rib to be integrally formed on the upper side of the separating disk. By the provision of such a supporting rib, a tilting movement of the separating disk oriented at an incline to the longitudinal axis of the housing can be counteracted in a structurally simple way.

In order to be able to support the flow-guiding element in an axial direction, the flow-guiding element in an advantageous embodiment of the invention comprises an axial extension that can be placed in contact against a top wall of the housing upper part. The axial extension is, for example, configured in the form of a hollow cylinder which has, on the outer side thereof, at least one supporting rib integrally formed thereon, wherein the supporting rib extends radially outwardly relative to the longitudinal axis of the hollow cylinder.

In a preferred configuration of the invention, the hollow cylinder has extending thereinto a pressure sensor with the aid of which the pressure difference between the dirty region and the clean region of the housing upper part can be detected. Advantageously, the interior space of the hollow cylinder is in flow communication with the dirty region of the filter device via a connecting channel integrally formed in the flow-guiding element so that the pressure of the hydraulic liquid prevailing in the dirty region can be detected within the interior space of the hollow cylinder. The pressure sensor may comprise a transverse bore via which the pressure of the hydraulic liquid prevailing in the clean region can be detected.

The pressure sensor is preferably configured as a pressure switch that changes its switch position depending on the pressure difference between the pressure prevailing in the dirty region and the pressure prevailing in the clean region.

The following description of an advantageous embodiment of the invention, taken in conjunction with the drawings, serves to explain the invention in greater detail.

### BRIEF DESCRIPTION OF THE DRAWINGS

FIG. 1 shows a perspective representation of an embodiment of a filter device;

FIG. 2 shows the filter device of FIG. 1 in a top view;

FIG. 3 shows a sectional view of the filter device along line 3-3 of FIG. 2;

FIG. 4 shows a sectional view of the filter device along line 4-4 of FIG. 2;

FIG. 5 shows a sectional view of the filter device along line 5-5 of FIG. 3;

FIG. 6 shows a sectional view of the filter device along line 6-6 of FIG. 3;

FIG. 7 shows a perspective representation of a housing upper part of the filter device of FIG. 1, as viewed obliquely from below;

FIG. 8 shows a perspective representation of a flow-guiding element of the filter device of FIG. 1, as viewed obliquely from below; and

FIG. 9 shows a perspective representation of the flow-guiding element of FIG. 8, as viewed obliquely from above.

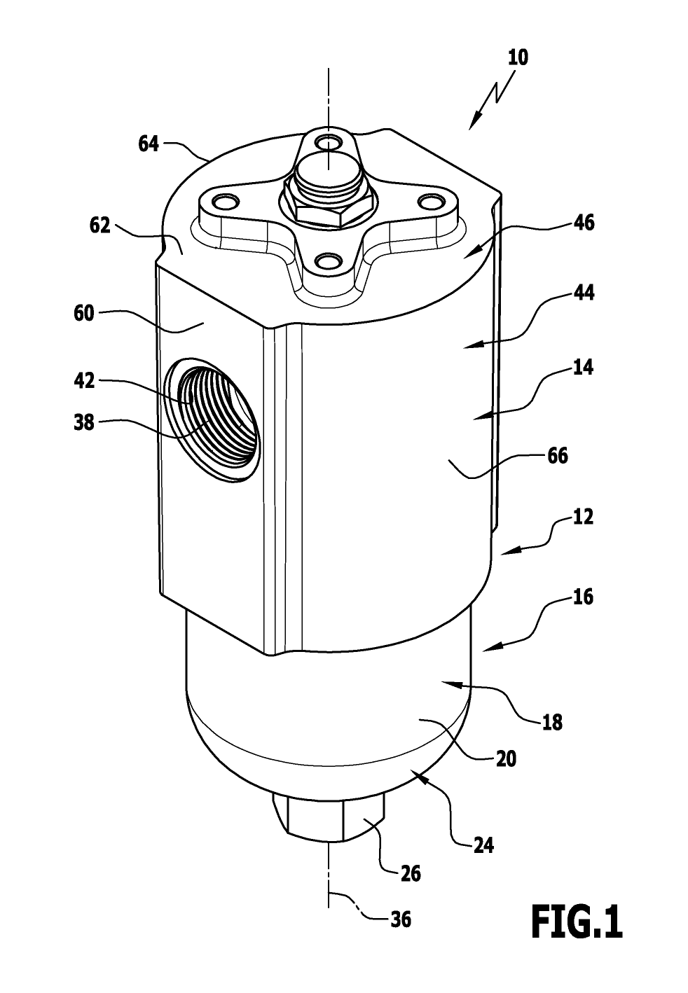

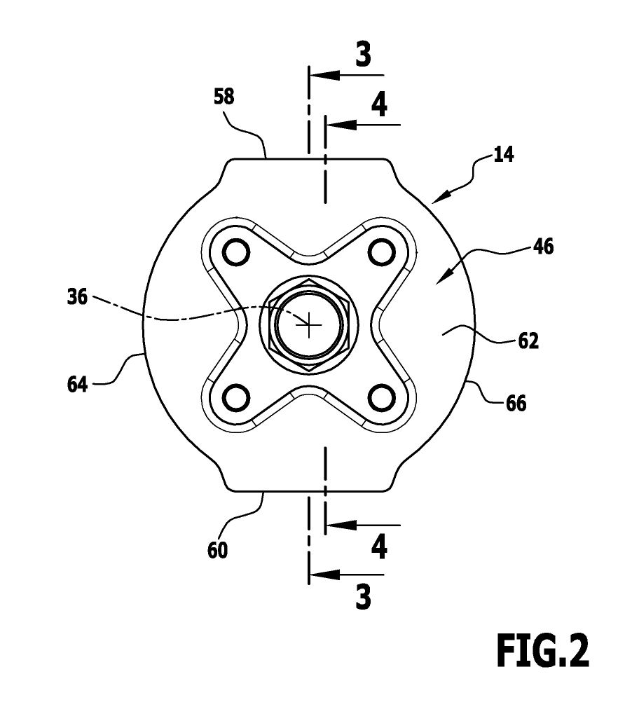

### DETAILED DESCRIPTION OF THE INVENTION

The drawing shows a schematic representation of an advantageous embodiment of a filter device constructed in accordance with the invention and generally designated by the reference numeral 10. The filter device 10 forms a pressure filter which permits the filtration of hydraulic liquid that is under a pressure of several 100 bar, for example under a pressure of 450 bar. The filter device 10 comprises a housing 12 having a housing upper part 14 and a housing lower part 16. The housing lower part 16 can be releasably connected to the housing upper part 14; in the exemplary embodiment as illustrated, the housing lower part 16 can be connected to the housing upper part 14 by screwing.

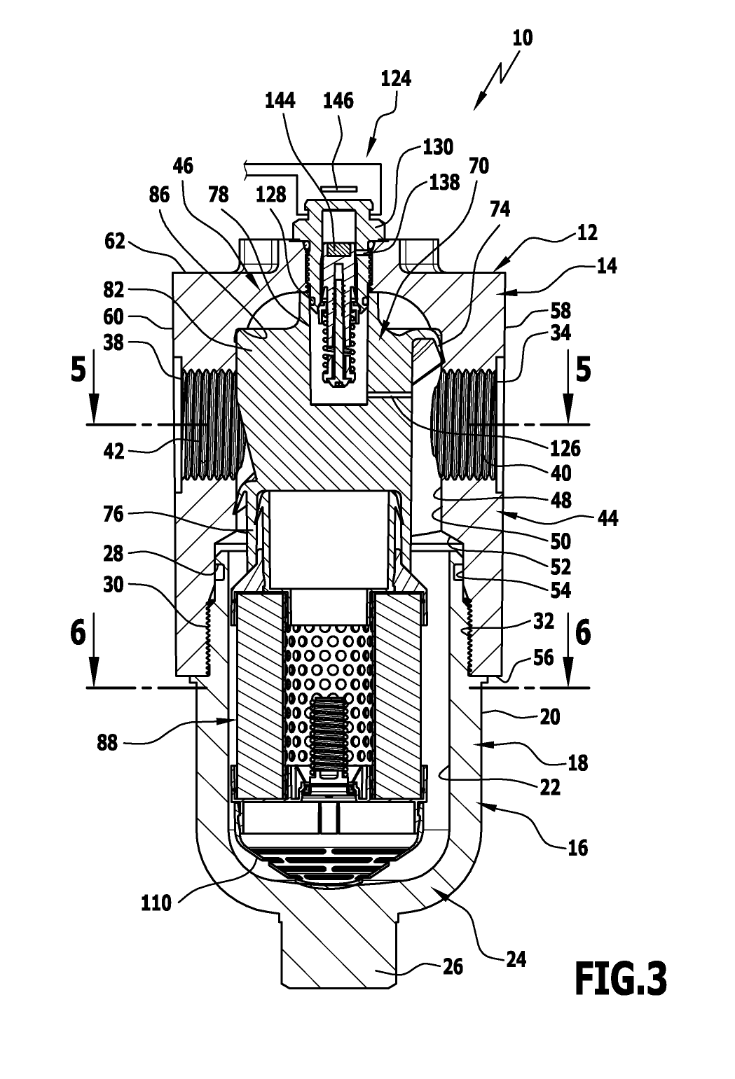

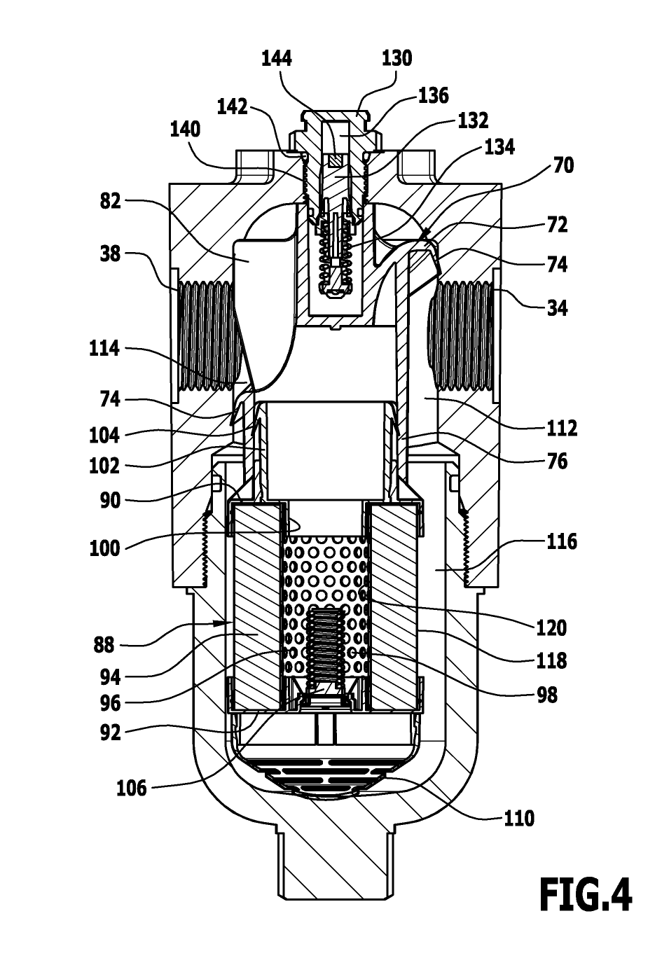

The housing lower part 16 is of a pot-shaped configuration; this is shown in FIGS. 3 and 4 in particular. It comprises a lower housing shell 18 with a circular-cylindrical exterior wall 20 and a circular-cylindrical interior wall 22 and a bottom 24 which is adjoined on the outer side thereof by a hexagon 26.

At its end region facing towards the housing upper part 14, the lower housing shell 18 has, on the outer side thereof, an annular groove 28 which receives a sealing ring which has been omitted from the drawing for clarity of illustration. At a location spaced apart from the annular groove 28, the shell 18 has, on the outer side thereof, an external thread 30 which can be threaded into a complementarily configured internal thread 32 of the housing upper part 14.

The housing upper part 14 comprises a housing inlet 34 and a housing outlet 38 arranged at the same level as the housing inlet 34 relative to a longitudinal axis 36 of the housing 12, with the housing outlet 38 being located diametrically opposite the housing inlet 34. The housing inlet 34 has an internal thread 40 for connecting a hydraulic conduit via which the filter device 10 can be supplied with hydraulic liquid that is to be filtered. In a corresponding manner, the housing outlet 38 comprises an internal thread 42 for connecting a hydraulic conduit via which hydraulic liquid that has been filtered can be removed from the filter device 10.

The housing upper part 14 has an upper housing shell 44 which is covered, on the side thereof facing away from the housing lower part 16, by a housing top 46. The upper housing shell 44 has an interior wall 48 which forms an elliptical-shaped interior wall section 50 at a level of the housing inlet 34 and the housing outlet 38 with respect to the longitudinal axis 36, said elliptical-shaped interior wall section 50 being adjoined by a transition section 52 in a direction towards the housing lower part 16. The transition section 52 forms a transition from the elliptical-shaped interior wall section 50 to a circular-shaped interior wall section 54 which extends as far as the lower end face 56 of the housing upper part 14 facing away from the housing top 46 and which comprises the internal thread 32.

The exterior wall of the upper housing shell 44 is formed by a first planar exterior wall section 58 in the area of the housing inlet 34 and a second planar exterior wall section 60 in the area of the housing outlet 38, each of which extends from an upper side 62 of the housing upper part 14 to the lower end face 56. The upper housing shell 44 forms, on the outer side thereof, a first circular arc-shaped exterior wall section 64 and a second circular arc-shaped exterior wall section 66 in a circumferential direction between the first planar exterior wall section 58 and the second planar exterior wall section 60, wherein the two circular arc-shaped exterior wall sections 64, 66 are located diametrically opposite each other and extend over an angular range of approximately 115° in the circumferential direction in each case.

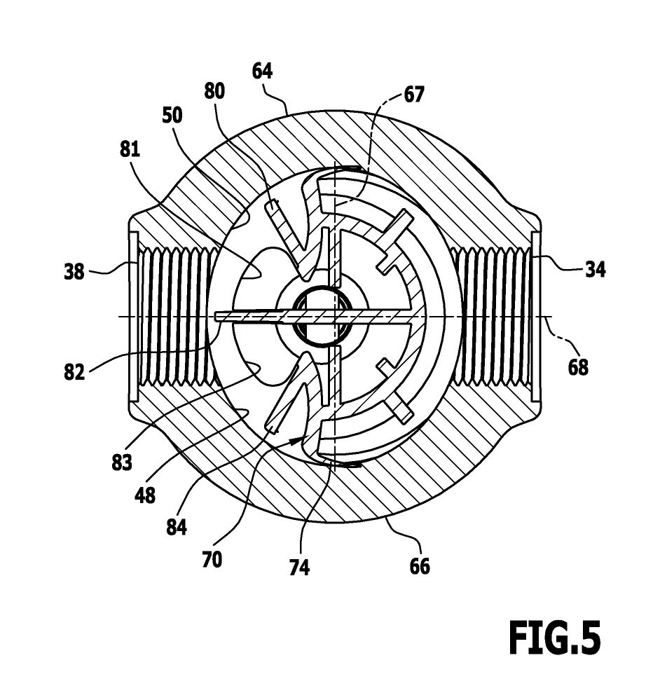

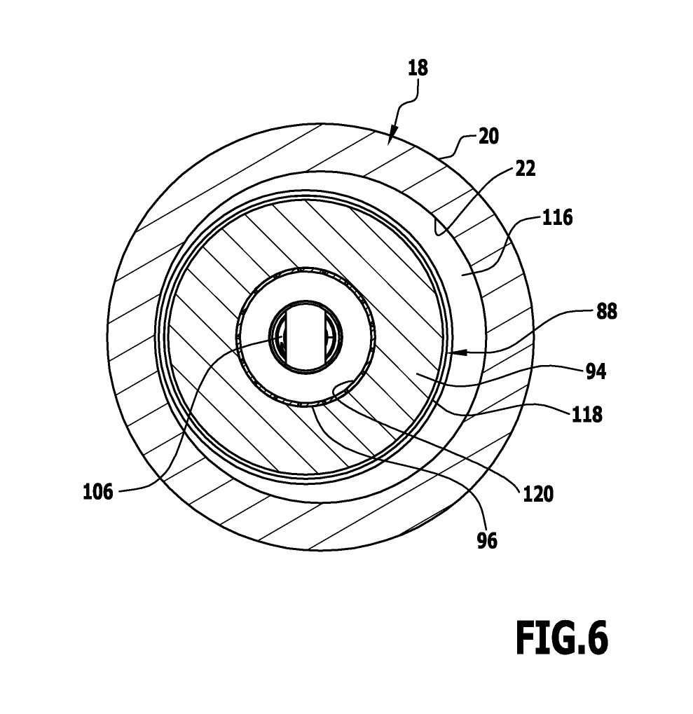

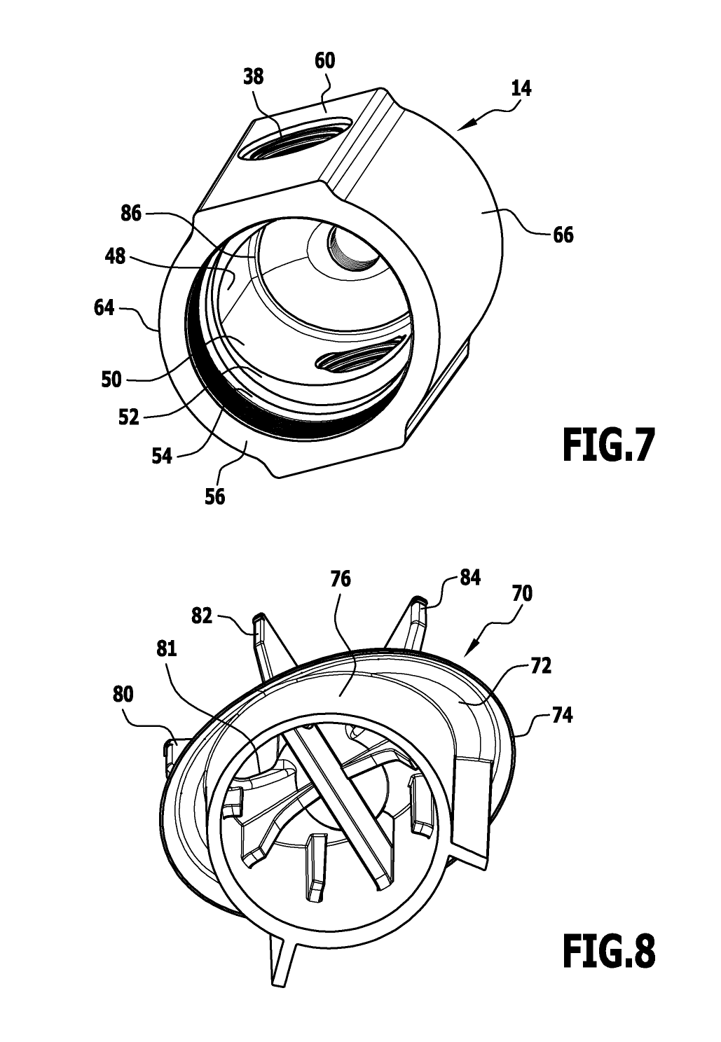

The main axis 67 of the elliptical-shaped interior wall section 50 is oriented perpendicularly to a connection axis 68 which connects the housing inlet 34 to the housing outlet 38. This is shown in FIG. 5 in particular. The provision of the elliptical-shaped interior wall section 50 and the circular arc-shaped exterior wall sections 64 and 66 results in the housing upper part 14 having a larger wall thickness in the area of the housing inlet 34 and in the area of the housing outlet 38 than in the remainder of the circumferential areas, wherein the areas of different material thickness of the housing upper part 14 transition one into the other continuously. Except for the internal threads 40 and 42, via which hydraulic liquid can flow into and out of the housing 12, the housing upper part 14 has no flow channels whatsoever; in particular, the housing upper part 14 contains no abrupt changes in material thickness, and hence no abrupt changes in stiffness, at which peak stresses adversely affecting the compressive rigidity of the housing 12 could occur under the influence of the pressurized hydraulic liquid.

Therefore, the housing upper part 14, like the housing lower part 16, is distinguished in that it provides very high compressive rigidity with relatively small material thickness.

Inserted in the housing upper part 14 is a flow-guiding element 70 which is configured as a one-piece, shaped plastic part and forms a separating disk 72 which is oriented obliquely with respect to the longitudinal axis 36 of the housing 12 and carries, on the outer circumference thereof, a sealing lip 74 integrally formed on the separating disk 72. The separating disk 72 is oriented such that the housing inlet 34 is arranged below the separating disk 72 and the housing outlet 38 is arranged above the separating disk 72. This is shown in FIG. 4 in particular.

Adjoining the separating disk 72 at the underside thereof and formed in one-piece construction therewith, is a sleeve-shaped coupling part 76 which extends as far as the level of the annular groove 28 integrally formed in the lower housing shell 18, with respect to the longitudinal axis 36.

Adjoining the separating disk 72 at the upper side thereof and extending coaxially with respect to the longitudinal axis 36 of the housing 12, is a projection in the form of a hollow cylinder 78 which is, at the end thereof facing away from the separating disk 72, supported on the housing top 46.

Integrally formed on the outer side of the hollow cylinder 78 and the upper side of the separating disk 72 are a first supporting rib 80, a second supporting rib 82 and a third supporting rib 84 with which the separating disk 72 is, on the side thereof facing away from the housing inlet 34, supported on the elliptical-shaped interior wall section 50. The supporting ribs 80, 82, 84 extend as far as the level of a radially inwardly oriented step 86 which extends uniformly over the entire circumference of the elliptical-shaped interior wall section 50 and which forms an axial stop for the supporting ribs 80, 82 and 84.

The housing lower part 16 surrounds a filter element which in the exemplary embodiment as illustrated is configured as a filter cartridge 88. The filter cartridge 88 comprises an upper end disk 90, facing towards the flow-guiding element 70, and a lower end disk 92, facing away from the flow-guiding element 70, which have extending therebetween a filter material 94 which has its inner side supported on a support tube 96. The support tube 96 has a plurality of through-openings 98, and the filter material is, in a conventional manner, pleated into a star-shaped configuration and permits passage of hydraulic liquid therethrough from outside to inside in a radial direction.

The upper end disk 90 comprises a discharge opening 100 via which filtered hydraulic liquid can flow out of the filter cartridge 88 in an axial direction. Held to the upper end disk 90 is a sleeve-shaped connecting part 102 which can be inserted into the sleeve-shaped coupling part 76 of the flow-guiding element 70 and carries, at its end region facing away from the upper end disk 90, on the outer side thereof, a sealing lip 104 which sealingly contacts the inner side of the sleeve-shaped coupling part 76.

A bypass valve 106 known per se is arranged at the lower end disk 92 in a conventional manner. The bypass valve 106 ensures that hydraulic liquid can pass through the filter cartridge 88 if the filter material 94 becomes clogged.

The lower end disk 92 is supported on the housing bottom 24 of the housing lower part 16 via a pot-shaped support element 110 comprising a plurality of through-openings.

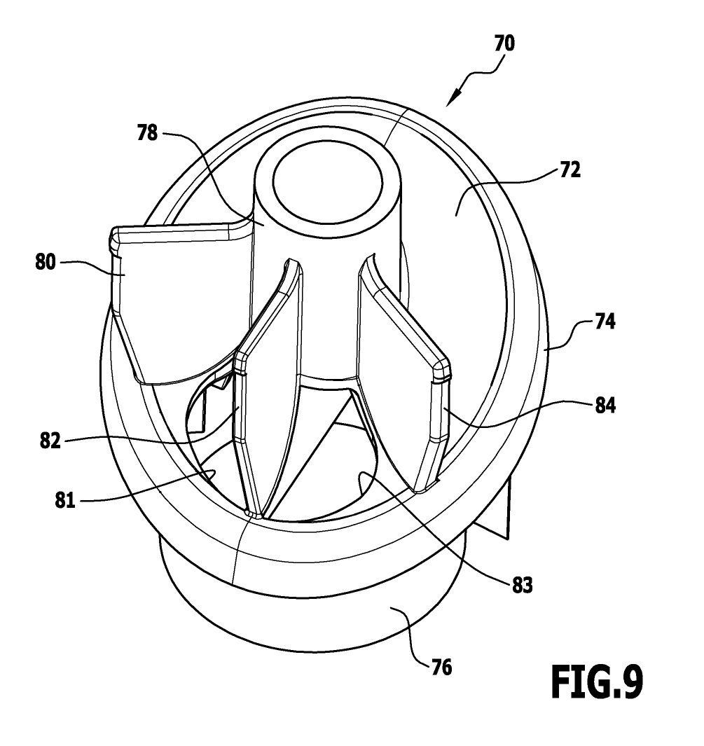

The separating disk 72 has a first passageway 81 between the first supporting rib 80 and the second supporting rib 82, and the separating disk 72 has a second passageway 83 between the second supporting rib 82 and the third supporting rib 84. This is shown in FIG. 9 in particular.

The flow-guiding element 70 divides the interior space of the housing upper part 14 into a dirty region 112 into which the housing inlet 34 opens and a clean region 114 from which the housing outlet 38 leads out. The dirty region 112 is in flow communication with the dirty side 118 of the filter cartridge 88 via an annular space 116 that surrounds the filter cartridge 88 in a circumferential direction. Liquid that is to be filtered can flow via the housing inlet 34 into the dirty region 112 and flow through the filter cartridge 88 radially from the outside to the inside. The hydraulic liquid thereby reaches the clean side 120 of the filter cartridge 88. The clean side 120 is arranged at the inner side of the filter material 94 and is, via the discharge opening 100 of the upper end disk 90, the connecting part 102 adjoining same and the coupling part 76, in flow communication with the first passageway 81 and the second passageway 83 of the separating disk 72, and the hydraulic liquid can, via the passageways 81, 83, reach the clean region 114 whence the filtered liquid can flow out of the housing 12 via the housing outlet 38.

When the filter cartridge 88 is to be replaced, then, to accomplish this, the housing lower part 16 can be screwed off the housing upper part 14 so that the filter cartridge 88 is accessible to the user. Once the filter cartridge 88 has been replaced, the housing lower part 16 can be again screwed together with the housing upper part 14.

The hydraulic liquid can have a pressure of several 100 bar. In spite of this heavy pressure load, the housing upper part 14 and the housing lower part 16 can be fabricated in a material-conserving manner, wherein a cold forming method or also a hot forming method can be used for fabricating the housing upper part 14 as well as for fabricating the housing lower part 16. In particular, provision may be made for the housing upper part 14 to be configured as an extruded steel part or as a forging.

In order to detect the pressure difference between the pressure of the hydraulic liquid prevailing in the dirty region 112 and the pressure of the hydraulic liquid prevailing in the clean region 114, the filter device 10 comprises a differential pressure sensor 124 which in the exemplary embodiment as illustrated is configured as a differential pressure switch and extends through the housing top 46 and into the hollow cylinder 78 of the flow-guiding element 70. The interior space of the hollow cylinder 78 is in flow communication with the dirty region 112 via a connecting channel 126 integrally formed in the flow-guiding element 70. In order to seal the interior space of the hollow cylinder 78, the differential pressure sensor 124 carries a first sealing ring 128 which sealingly contacts the inner side of the hollow cylinder 78. The differential pressure sensor comprises a sensor housing 130 which is screwed into the housing top 46 and which has a piston 132 held therein for reciprocating displacement coaxially with the longitudinal axis 36 of the housing 12. The lower side of the piston 132, which faces towards the flow-guiding element 70, is acted upon against the force of a return spring 134 by the pressure prevailing within the interior space of the hollow cylinder 78, i.e. the pressure of the dirty region 112, and the upper side of the piston 132, which faces away from the flow-guiding element 70, is acted upon by the pressure prevailing in the clean region 114. To this end, the interior space 136 of the sensor housing 130 arranged above the piston 132 is in flow communication with the clean region 114 via a transverse bore 138 and a thread 140. At a location above the transverse bore 138, the thread 140 is sealed by way of a second sealing ring 142. Held to the piston 132 is a permanent magnet 144 which has associated therewith a magnetic field-sensitive element 146 arranged outside of the sensor housing 130. In the exemplary embodiment as illustrated, the magnetic field-sensitive element 146 is configured as a reed contact.

Depending on how large the pressure difference between the pressure prevailing in the dirty region 112 and the pressure prevailing in the clean region 114 is, the piston 132 and hence the permanent magnet 144 assume a distance from the magnetic field-sensitive element 146 that is predetermined by the force of the return spring 134. The strength of the magnetic field prevailing at the location of the magnetic field-sensitive element 146 therefore depends on the pressure difference so that a differential pressure-dependent sensor signal can be provided by the magnetic field-sensitive element. The pressure difference depends on the degree of fouling of the filter material 94. The greater the degree of fouling, the greater the pressure difference which is sensed by the differential pressure sensor 124. Hence, a signal dependent on the degree of fouling of the filter material can be provided by way of the differential pressure sensor 124.

What is claimed is:

1. Filter device for filtering a hydraulic liquid, comprising a housing having a housing upper part and a housing lower part that is releasably connectable to the housing upper part, wherein the housing upper part has a housing inlet for hydraulic liquid that is to be filtered and a housing outlet for hydraulic liquid that has been filtered and wherein a filter element is arranged in the housing lower part whose dirty side is in flow communication with the housing inlet and whose clean side is in flow communication with the housing outlet, wherein the housing upper part comprises an interior wall that is curved convexly outward along the entire circumference thereof and wherein an insertable flow-guiding element is arranged in the housing upper part which divides the interior space of the housing upper part in a dirty region and a clean region, wherein the dirty region is in flow communication with the dirty side of the filter element and the housing inlet opens into the dirty region and wherein the clean region is in flow communication with the clean side of the filter element and the housing outlet leads out of the clean region.

2. Filter device in accordance with claim 1, wherein the interior wall of the housing upper part is configured with a circular or elliptical shape in a plane oriented perpendicularly to a longitudinal axis of the housing.

3. Filter device in accordance with claim 1, wherein the interior wall of the housing upper part has an elliptical-shaped interior wall section at a level of the housing inlet and the housing outlet relative to the longitudinal axis of the housing and wherein the interior wall of the housing upper part has a circular-shaped interior wall section in an end region that faces towards the housing lower part.

4. Filter device in accordance with claim 1, wherein the housing upper part comprises exterior wall sections curved convexly outward in a circumferential direction between the housing inlet and the housing outlet.

5. Filter device in accordance with claim 4, wherein the exterior wall sections of the housing upper part are of circular arc-shaped or elliptical arc-shaped configuration.

6. Filter device in accordance with claim 1, wherein the housing upper part comprises areas of different material thicknesses which transition continuously one into the other.

7. Filter device in accordance with claim 1, wherein the housing outlet is located diametrically opposite the housing inlet.

8. Filter device in accordance with claim 1, wherein the housing inlet and the housing outlet are arranged at the same level relative to the longitudinal axis of the housing.

9. Filter device in accordance with claim 1, wherein the housing upper part is fabricated by cold or hot forming.

10. Filter device in accordance with claim 1, wherein the flow-guiding element comprises a separating disk having a sealing element which is placeable into sealing contact against the interior wall of the housing upper part.

11. Filter device in accordance with claim 10, wherein the sealing element forms a sealing lip integrally formed on the separating disk.

12. Filter device in accordance with claim 10, wherein the separating disk is at an incline with respect to the longitudinal axis of the housing, wherein the housing inlet opens into the housing upper part on a first side of the separating disk and wherein the housing outlet leads out of the housing upper part on the second side of the separating disk, opposite the first side thereof.

13. Filter device in accordance with claim 12, wherein the first side of the separating disk faces towards the filter element and wherein the second side of the separating disk faces away from the filter element.

14. Filter device in accordance with claim 10, wherein the filter element forms a cylindrical filter cartridge which is connectable to the flow-guiding element in a releasable and flow-tight manner and wherein the flow-guiding element has at least one passageway for filtered hydraulic liquid.

15. Filter device in accordance with claim 14, wherein the filter cartridge comprises an upper end disk, facing towards the flow-guiding element, and a lower end disk, facing away from the flow-guiding element, which have a filter material arranged therebetween, wherein a sleeve-shaped connecting part is arranged at the upper end disk, said sleeve-shaped connecting part being releasably connectable to a sleeve-shaped coupling part of the flow-guiding element.

16. Filter device in accordance with claim 15, wherein the connecting part and the coupling part are pluggably connectable together.

17. Filter device in accordance with claim 16, wherein a sealing element is arranged at the connecting part and/or at the coupling part.

18. Filter device in accordance with claim 17, wherein the sealing element is integrally formed on the connecting part or on the coupling part.

19. Filter device in accordance with claim 18, wherein the sealing element is configured as a sealing lip.

20. Filter device in accordance with claim 1, wherein the flow-guiding element comprises at least one supporting rib that is placeable in contact against the interior wall of the housing upper part.

21. Filter device in accordance with claim 1, wherein the flow-guiding element comprises an axial extension that is placeable in contact against a top wall of the housing upper part.
